(19) United States
(12) Patent Application Publication
(10) Pub. No.: US 2007/0153738 A1
(43) Pub. Date: Jul. 5, 2007

(54) Method for switching the use of an access point (AP) within a wireless communications network

(76) Inventors: Charles R. Barker JR., Orlando, FL (US); Keith J. Goldberg, Casselberry, FL (US); Robin U. Roberts, Orlando, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/321,672

(22) Filed: Dec. 29, 2005

(51) Int. Cl. H04Q 7/00; H04L 12/56

(52) U.S. Cl. 370/331; 370/401

(57) ABSTRACT

A method for switching the use of an access point (AP) in a wireless communication network without explicitly updating a proxy address resolution protocol (ARP) cache (200) includes first providing a communication between a network node (111) and a first access point (107) utilizing a first proxy ARP cache. The communication is then switched from the first access point (107) to a second access point (109) utilizing a second proxy ARP cache. In order to reduce messaging traffic in the wireless communications network, any future inquiries regarding the address of the network node (111′) continue to be serviced by the first access point (107) and its first proxy ARP cache.

### FIELD OF THE INVENTION

The present invention relates generally to proxy cache updating and more particularly to the operation of proxy address resolution protocol (ARP) cache with node movement in a wireless communications network

### BACKGROUND

Wireless communication networks, such as mobile wireless telephone networks, have become increasingly prevalent. These wireless communications networks are commonly referred to as “cellular networks”, because the network infrastructure is arranged to divide the service area into a plurality of regions called “cells”. A terrestrial cellular network includes a plurality of interconnected base stations, or base nodes, that are distributed geographically at designated locations throughout the service area. Each base node includes one or more transceivers that are capable of transmitting and receiving electromagnetic signals, such as radio frequency (RF) communications signals, to and from mobile user nodes, such as wireless telephones, located within the coverage area. The communications signals include, for example, voice data that has been modulated according to a desired modulation technique and transmitted as data packets. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format, which enables a single transceiver at a first node to communicate simultaneously with several other nodes in its coverage area.

In recent years, a type of mobile communications network known as an “ad-hoc” network has been developed. In this type of network, each mobile node is capable of operating as a base station or router for the other mobile nodes, thus eliminating the need for a fixed infrastructure of base stations.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet.

In one type of ad-hoc network, a typical mesh type network topology broadcasts data to the entire mesh network that can be very inefficient and costly. Although the mesh network is efficient at moving unicast data, any broadcast data typically must be flooded over the entire network. This flooding incurs a high cost of network resources since a message is repeated once by every node in the mesh network. This generally occurs at a slow data rate, thereby consuming a relatively large amount of air time and battery life for portable devices. An Address Resolution Protocol (ARP) message includes a broadcast message as well as an ARP request message that can consume a considerable amount of communications bandwidth. This occurs even though the target of the request can be proximately located to the sender or located on the wired network. ARP, for example, is described in Ethernet Address Resolution Protocol RFC 826 (http://www.ietf.org/rfc/rfc826.txt) and was originally designed for use on a simple “wired” logical sub-network where a broadcast message uses no more resources than a unicast message.

Although some switches and routers have ARP proxy services to prevent ARP messages from passing over slow links, these types of methods do not address the needs of a dynamic and mobile wireless mesh network. Those skilled in the art will recognize that a mobile system typically includes a subscriber who moves rapidly between points of presence on the wired network. ARP messages traveling in slow links would not operate effectively in this type of wireless environment and methods for handling these broadcasts in the wireless network must be addressed. The use of ARPs as it relates to media access control (MAC) in the use of an intelligent access point (IAP) is well known in the art as, for example, is disclosed by Barker, Jr. in U.S. Pat. No. 6,771,666 entitled “System and method for trans-medium address resolution on an ad-hoc network with at least one highly disconnected medium having multiple access points to other media” granted Aug. 3, 2004, and owned by the assignee of the present invention, which is herein incorporated by reference.

Methods involving the transmission of unicast messages over a broadcast network have been addressed in the prior art. For example, U.S. Patent Publication No. US 2005/0084082 to Horvitz et al., entitled “Designs, interfaces, and policies for systems that enhance communication and minimize disruption by encoding preferences and situations,” filed Jun. 30, 2004 describes a system for enhancing communications to minimize disruption through the use of encoding preferences. The Horvitz et al. patent publication is a complex system for channel selection, routing and rescheduling operations utilizing user preferences for real time call handling. Similarly, U.S. Patent Publication No. US 2005/0141706 to Regli et al., entitled “System and method for secure ad hoc mobile communications and applications,” filed Dec. 29, 2004 teaches a system for secure ad hoc mobile communications that uses a mobile agent using middleware to bridge the gap between old and ad hoc network infrastructures. This system is also complex requiring sophisticated applications to bridge communications in a dynamic network environment. Additional prior art topologies also describe moving ARP packets over unicast only media (such as IP packet tunnels) but these types of systems do not address the broadcast capable mesh network. Although a dynamic host configuration protocol (DHCP) mechanism is relatively simple and stateless, compared to the ARP mechanism, the ARP mechanism requires proxy services and spoofing of messages. This results in a much more complex mechanism.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating the use of basic address resolution protocol (ARP) tunnel and proxy on a wireless mesh network in accordance with an embodiment of the invention.

FIG. 2 is a block diagram illustrating a lazy update proxy cache mechanism in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to tunneling and proxying of address resolution protocol messages for improving efficiency in a wireless mesh network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions to tunneling and proxying of address resolution protocol messages for improving efficiency in a wireless mesh network described herein. The non-processor circuits may include, but are not limited to, a radio receiver, a radio transmitter, signal drivers, clock circuits, power source circuits, and user input devices. As such, these functions may be interpreted as steps of a method to perform tunneling and proxying of address resolution protocol messages for improving efficiency in a wireless mesh network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

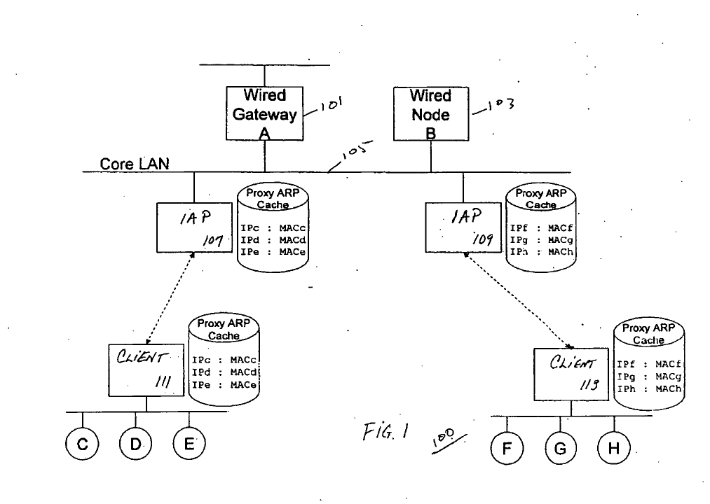

Turning now to FIG. 1, basic ARP tunneling and proxy addresses are used in a wireless network 100 to provide communication amongst wired and wireless devices. A wired gateway 101 and wired node 103 both utilize a core local area network (LAN) 105 for providing digital communications over a wired network. Intelligent access points (IAPs) such as an access point 107 and an access point 109 are used to provide communication access by a wireless client 111 and a wireless client 113. The wireless client 111 also provides access on behalf of one or more wired nodes C, D and E while the wireless client 113 provides access for one or more nodes F, G and H. It will be appreciated by those of ordinary skill in the art that nodes C, D, E and nodes F, G, H may each be individual users using any type of wired or wireless communications device such as a laptop, a cellular telephone, a pager, a personal digital assistant (PDA) or the like. These nodes are unaware of and do not participate in the negotiation of access with the IAPs. In operation, the ARP cache is used to prevent broadcast traffic from being sent to each node over the entire network. Such a broadcast communication utilizes excessive system resources such as data bandwidth not to mention the battery drain on the wireless communications devices. As noted herein, both Internet protocol (IP) addresses and MAC addresses are used to provide communication among devices. Both the access points 107, 109 and the clients 111, 113 utilize a memory such as a proxy ARP cache to pair both an IP address and a MAC address in order to provide effective communication. As seen in FIG. 1, each proxy ARP cache includes an IP address for a specific node as well as its corresponding MAC address.

The proxy ARP cache as used at the access point and at the client in the wireless network 100 works to resolve inquiries from nodes regarding both IP and MAC addresses. The inquiries are resolved at the access point or client without performing a general broadcast communication to all nodes within entire network. For example, if node C requests information regarding node E, client 111 will drop the request silently, allowing node E to respond on its own behalf and preventing the request from being broadcast over the entire network. This is accomplished since node E is able to directly reply to node C without requesting address information from other access points or clients. Similarly, if a request is made from the wired gateway 101 or from node F regarding information about node E, then the access point 107 will reply without sending a broadcast communication over the entire network. In this scenario, access point 109, using its proxy ARP cache, will allow any broadcast ARP request to be dropped. This prevents any broadcast ARP request message from entering the other portions of the mesh network. If node F requests information regarding node E, then the client 113 will tunnel the request to access point 109 which will broadcast the request on the core LAN 105. At this point, access point 107 will respond on behalf of node E.

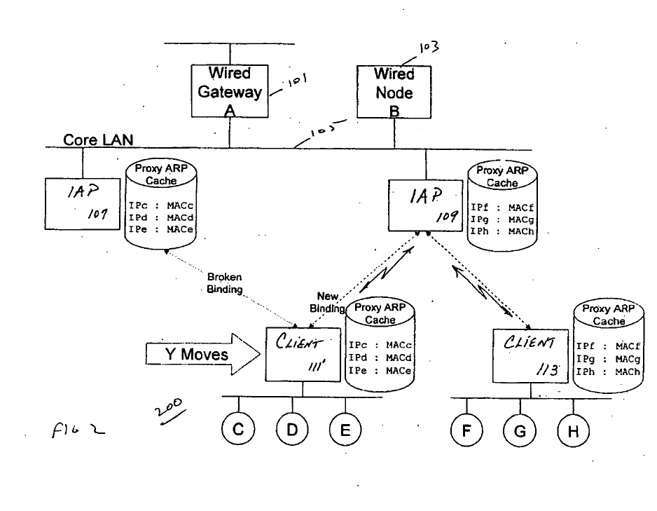

FIG. 2 illustrates the ARP tunnel and proxy wireless network as shown in FIG. 1. However the client 111′ has moved its position such that it no longer is in wireless communication with access point 107. Instead, client 111′ is in communication with access point 109 along with client 113. In this situation the process that would typically occur would be that the content within the proxy ARP cache from the client 111′ would be conveyed to the proxy ARP cache at access point 109. Those skilled in the art will recognize that conveying this information can require expending a tremendous amount of network resources in bandwidth and time in order to continually update the proxy ARP cache at access point 109 with IP and MAC address information for nodes associated with client 111′ and remove the same information from the cache at the old access point, 107. In order to prevent such an update, the invention provides for the use of a “lazy update” where the client 111′ will maintain its local address cache but is not required to explicitly update the proxy ARP cache at the access point 109 when client 111′ is associated with that access point. Since the proxy ARP cache at client 111′ is not required to update upon binding to access point 109, this reduces the overall messaging and expending of network resources required for each binding change.

In terms of the resources expended by the wireless network 100, it makes no difference which access point issues information about a specific node. Access point 107 can continue to issue information on behalf of client 111′ and nodes C, D, or E since this information can be conveyed along the core LAN 105. This will occur until each proxy cache entry is cleared upon reception of an ARP request from the core LAN 105 having a proxied node as the source. Likewise, the proxy ARP cache at access point 109 will not receive any new entries until nodes C, D or E happen to send an ARP request. This allows the proxy ARP cache entries at access point 109 to be added individually as packets pass through and are read or “sniffed” by the access point 109. Because the same ARP request message from a client causes both the creation of its entry into the new proxy ARP cache and the removal of its entry from the old proxy ARP cache, coherency is maintained across all caches on the network and no two access point caches will contain the same entry.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for switching the use of an access point (AP) in a wireless communication network comprising the steps of:
providing a communication between at least one node and a first access point utilizing a first proxy Address Resolution Protocol (ARP) cache;
switching the communication from the first access point to a second access point utilizing a second proxy ARP cache; and
continuing to service inquiries regarding an address of the at least one node by the first access point utilizing the first proxy ARP cache.

2. A method for switching the use of an AP as in claim 1, wherein inquires continue to be serviced for reducing messaging traffic in the wireless communications network.

3. A method for switching the use of an AP as in claim 1, wherein the inquiries regarding the node include inquiries regarding one or more addresses selected from a group comprising an Internet protocol (IP) address and a media access control (MAC) address.

4. A method for switching the use of an AP as in claim 1, wherein at least one node communicates to the first access point and the second access point through a wireless client.

5. A method for utilizing a proxy address resolution protocol (ARP) cache during movement of a mobile node in a wireless communications network comprising the steps of:
providing a first access point communicating with a local area network (LAN) for allowing at least one wireless node to communicate with the LAN;
providing a first proxy ARP cache associated with the first access point for servicing inquiries about the at least one wireless node;
migrating the communication of the at least one wireless node from the first access point to a second access point having a second proxy ARP cache; and
allowing the first ARP cache to continue to reply to inquiries regarding the at least one wireless node in order to reduce network bandwidth on the wireless communications network.

6. A method for utilizing a proxy address ARP cache as in claim 5, wherein the at least one wireless node communicates with the first access point and the second access point through a wireless client device.

7. A method for utilizing a proxy address ARP cache as in claim 5, wherein the inquiries include inquiries regarding one or more addresses selected from a group comprising an Internet protocol (IP) address and a media access control (MAC) address.

8. A method for reducing broadcast traffic in a wireless communications network utilizing a proxy address resolution protocol (ARP) cache associated with at least one access point comprising the steps of:
providing a first access point having a first proxy ARP cache for communicating with a local area network (LAN);
providing a client device for communicating with the first access point and at least one communications node;
transitioning communications with the client device from the first access point to a second access point having a second proxy ARP cache; and
utilizing the first ARP cache for answering address inquiries regarding the client device such that the second proxy ARP cache is not updated with information from the first proxy ARP cache.

9. A method for reducing broadcast traffic in a wireless network as in claim 8, wherein the first proxy ARP cache and the second proxy ARP cache include one or more addresses selected from a group comprising an Internet protocol (IP) address and a media access control (MAC) address information.

10. A method for reducing broadcast traffic in a wireless network as in claim 8, wherein address inquiries are sent via the first access point over the LAN via the second access point.

11. A method for reducing broadcast traffic in a wireless network as in claim 8, wherein the address information regarding the at least one communications node requires no broadcast to other communication nodes to update address information.

12. A method for reducing broadcast traffic in a wireless network as in claim 8, wherein the address information regarding the at least one communications node transfers from the first proxy ARP cache to the second proxy ARP cache at some time after the client device transits to the second access point.
